(19) United States
(12) Patent Application Publication
(10) Pub. No.: US 2010/0145784 A1
(43) Pub. Date: Jun. 10, 2010

(54) METHOD AND SYSTEM FOR TIME-AND LOCATION-SENSITIVE CUSTOMER LOYALTY REWARDS PROGRAM

(75) Inventors: Joseph Sriver, Minneapolis, MN (US); David Borrillo, Rochester, MN (US); Wade Beavers, Rochester, MN (US)

Correspondence Address: PERKINS COIE LLP, P.O. BOX 1208, SEATTLE, WA, 98111-1208, US

(73) Assignee: DoApp, Inc., Minneapolis, MN (US)

(21) Appl. No.: 12/606,018

(22) Filed: Oct. 26, 2009

Related U.S. Application Data
(60) Provisional application No. 61/119,807, filed on Dec. 4, 2008.

(51) Int. Cl. G06Q 30/00; G01C 21/00; H04W 4/12

(52) U.S. Cl. 705/14.25; 701/213; 701/300; 705/14.35; 455/466

(57) ABSTRACT

A method and system for transmitting a time- and location-sensitive discount code to a user participating in a loyalty program. The method includes determining a physical location of a user mobile device. The method includes determining a user local time. The method includes analyzing a user purchase history stored within a loyalty program data store. The method includes selecting a discount code based, in part, on the location, the local time, and the user purchase history. The method includes transmitting the discount code to the user mobile device.

### CROSS REFERENCE TO RELATED APPLICATIONS

This application claims priority to provisional application No. 61/119,807 entitled “METHOD AND SYSTEM FOR TIME- AND LOCATION-SENSITIVE CUSTOMER LOYALTY REWARDS PROGRAM”, filed Dec. 4, 2008, and which is incorporated herein by reference.

This application is related to provisional application No. 60/041,789 entitled “METHOD AND SYSTEM FOR SELECTING TIME- AND LOCATION-RELEVANT ADVERTISEMENTS AND ITINERARY BUILDING”, filed Apr. 2, 2008, and which is incorporated herein by reference.

### BACKGROUND

Loyalty programs are structured marketing efforts that reward and encourage repeat customer buying behavior. Other customer behavior can also be rewarded, such as referring additional customers or publicly praising a product or service.

In retailing, a loyalty card, rewards card, points card, advantage card, or club card is a plastic or paper card, visually similar to a credit card or debit card, which identifies the card holder as a member in a loyalty program. Other embodiments of the loyalty card can include a barcode, a machine-readable magnetic stripe, or RFID chips. Other embodiments of the loyalty card can be small key ring cards or key fobs.

A retail merchant can issue a loyalty card to a consumer who then uses it when interacting with the issuing merchant. By presenting the card at time of purchase, the consumer is typically entitled to either a discount on the current purchase or some other consideration (such as points) for future purchases. Each consumer is associated with a consumer profile in the merchant's database along with consumer interactions with the merchant for data mining purposes. For example, the merchant can infer a customer's favorite brand of electronics or beer from previous customer purchases.

The issuing merchant can require customers provide identifying or demographic data, such as a name and an address. This information is associated with the consumer profile. Customer application forms for loyalty programs usually entail agreements by the merchant concerning customer privacy, typically non-disclosure of non-aggregate customer data.

Conventional loyalty programs reward customers for repeat purchases and track customer purchases. However, loyalty programs and associated data are typically not used by the merchant in an active manner.

Mobile devices can be configured to determine a local position and time. Local time can be determined from an on-board clock or from periodic update clock signals from nearby cellular towers.

A physical location of a mobile device can be determined with various techniques. A Global Positioning System (GPS) receiver system utilizes satellite signals to calculate an accurate physical location. A cellular network triangulation system utilizes received signals and signal strengths from multiple cellular towers to triangulate a physical location. A short-range wireless network detection system detects the presence of nearby access points. Because such access points have a very short range, a physical location can be approximated as the location of the access points.

Online advertisements can be delivered to users for the purpose of advertising a product or service. One challenge facing advertisers is delivering relevant ads to interested viewers. For example, Google associates text ads with content by selecting relevant text ads based on the content of specific web pages. Other companies like Amazon personalize product offerings based on perceived customer preferences and past behaviors. Unfortunately, keyword- and behavior-based advertising is now prevalent on the Internet, thus making these techniques less effective.

Traditional advertisements in media can be localized in a geographical area, such as a city, state or region of the viewers. Another method of advertising is based on zip code or general location of the viewers. Location-based advertisement targeting allows a more focused and effective advertising effort. Some attempts have been made to utilize location-based advertising on the Internet with techniques such as reverse IP analysis. Unfortunately, such attempts are not always accurate because of proxy servers, virtual private networks, virtualization, remote connections, and other technical issues. Further, such techniques are ineffective if the user is not on an IP address that can be analyzed for a physical location.

Thus, there is a need to improve reward effectiveness in customer loyalty programs and to capitalize on customers identified through data collected by the programs.

### BRIEF DESCRIPTION OF DRAWINGS

The features and objects of the present disclosure will become more apparent with reference to the following description taken in conjunction with the accompanying drawings wherein like reference numerals denote like elements and in which:

FIG. 1A illustrates a screen shot of a first discount code on a mobile device.

FIG. 1B illustrates a screen shot of a second discount code on a mobile device.

FIG. 2 illustrates an example system for delivering discount codes to a user.

FIG. 3 illustrates an example mobile device for receiving and displaying discount codes to a user.

FIG. 4 illustrates an example server for selecting and transmitting discount codes to a user.

FIG. 5 illustrates a procedure for selecting and transmitting discount codes to a user.

### DETAILED DESCRIPTION

A method and system for providing time- and location-sensitive loyalty program discount rewards to customer members. A merchant can provide a loyalty program which tracks customer purchase history and demographic information. The loyalty program information can be analyzed in conjunction with a customer's geographic location and local time obtained from a customer's mobile phone. Together, the above information is analyzed for appropriate time- and location-sensitive discount rewards or ads to transmit to the customer. For example, the discounts can be transmitted to a single customer or a subset of customers participating in the loyalty program.

In one embodiment, a customized method allows retailers to provide personalized discounts based on a customer's buying history and then advertise through a mobile device (text messaging), web service, or mobile application. The discounts are associated with a location (for example, valid at a specific store) and time (for example, an expiration date/time). This allows retailers to engage with customers in a customized manner through their loyalty or reward programs via location and time based promotions based on customer purchase history.

In one example, a customer purchases 50 inch plasma television set from a local electronics store. The retailer provides loyalty or reward points for the purchase. A few days later, the retailer sends the customer a text message with an offer: come into the store from 5 to 9 pm tonight, purchase a Blue Ray DVD Player for $199 and any DVD's for 20% off. The text message includes a discount code to show a clerk at checkout. The discount code expires by the expiration time and is usable by the selected customer only. The discount code can be created from a customer relationship management (CRM) system and is associated with the specific customer and a designated start and end date.

This concept would be helpful to gain more purchases from customers who frequent a merchant or retailer. Furthermore, this allows discounts to be sent specifically and directly to potential customers known to be more likely to purchase based on their purchase history and other information. For example, customers with high conversion rates to such discounts can be targeted for further discounts.

In another embodiment, a user can download an application for installation on a mobile device, such as a cellular phone. Customized discounts can be received as notifications on the phone through the application utilizing the location of the phone and the time of day. In one example, this is useful for loyalty programs of merchants with multiple locations, such as chain coffee shops. A user living in Rochester, Minn. takes a trip to San Francisco for the weekend. The application has location based technology, which transmits a current location of the mobile device to the merchant. The coffee shop chain can send a customized coffee deal based on what type of coffee the user previously bought and inform the user that a coffee shop is located nearby, with appropriate directions. A notification is sent to the user and is an icon on the user's mobile device informing the user that a free Cafe Mocha is available at the specified coffee shop with a map and directions from the user's current location. The discount expires within a given time window. This would allow retailers and services to clear out specified product (for example, products nearing expiration) at a discount to a base of loyal customers.

One example can be a bakery with a loyalty program. The bakery can track bread and other baked goods that are almost expired, and send out specific deals as a text message to customers with custom deals for each of them. This rewards loyal customers with discounts and improves the merchant's inventory control.

Customers can have the ability to pull loyalty deals and discounts based on their location. For example, a customer who lives in Rochester, Minn. and travels to Orlando, Fla. could have the application query a retailer server to see if any time and location based deals are available in the local area.

Besides bricks and mortar location loyalty notifications, the user could utilize the ability to make the purchase online. The user can received personalized discounts, complete a transaction online through a retailer website or a commerce-based application. The user can either pick up the product from a specified location or have the product shipped to a user-specified address.

In another embodiment, CRM applications collect information on consumers buying habits, preferences, and other behaviors that can be monitored online. Mobile devices provide the capability to monitor user behaviors and collect information not available using only online methods, such as the customer's location and activities at any point in time. Thus, a loyalty program can be targeted to a specific customer at a specific place and time-which essentially takes personalization and CRM to the next level by personalizing an offer for each customer including better deals for high-value, repeat customers as well as special introductory offers for new customers. Finally, the offers can have complementary “chaining” where one offer complements another and leads to a rebate at another establishment based on the customer needs discovered at the first establishment.

In one example, consider an oil change establishment (ABC Oil Change) that sends its loyal customers reminders for oil changes with a rebate for the next oil change. Assume the customer comes in for the oil change and uses the rebate provided by ABC. During the oil change, the mechanic sees that the gas tank is only a quarter-tank full. He marks that in his CRM system. That in turn alerts two gas stations: one to the east of ABC and the other to the south of ABC. After the oil change, the customer has the GPS on her phone set for a destination to the east. When the customer leaves ABC, she gets a coupon for the gas station to the east that is on her way. The coupon can be indicated by flashing icons on the GPS map indicating that gas is getting low and a gas station with a discount coupon is on the way to the destination. This creates a coupon/loyalty/rebate chain personalized to a specific customer's location and needs. This can be extended to other products. For example, the ABC mechanic notices a floor mat is missing, and flags it in the CRM tool. An appropriate auto shop on the destination route can offer a deal or discount on a floor mat.

Other enhancements of personalization can be applied. For example, “application chaining” combined with rebate chaining. Application chaining is where multiple applications are used to extract information about the person's environment. For example, consider a case where someone is on their way to an outdoor football game. The temperature is 30 degrees below normal for the time of year and snow is starting to fall. The GPS on the mobile device is aware that the destination is the football game and can get the temperature and the fact that it is snowing at the stadium. There is a Kmart on the road to the destination, so the mobile device alerts the person that Kmart has a blue-light special on wool hats and blankets. This is not necessarily personalized, but just general information that is passed on because of the person's environment, location, environment, and possible needs are known. It could include multiple products as well such as gloves, coats, or even hot chocolate.

A next level of application chaining can occur when all devices communicate and share information. For example, an automobile's computer can monitor the windshield wiper fluid level and send a message when the fluids are low. It could send an alert to a GPS-enabled mobile device which in turn could evaluate the weather and see that inclement weather is coming and indicate that an auto shop located on the route has a sale on windshield wiper fluid.

It will be appreciated that in addition to ads and discount codes, addition rewards or prizes can be provided to the user through the loyalty program.

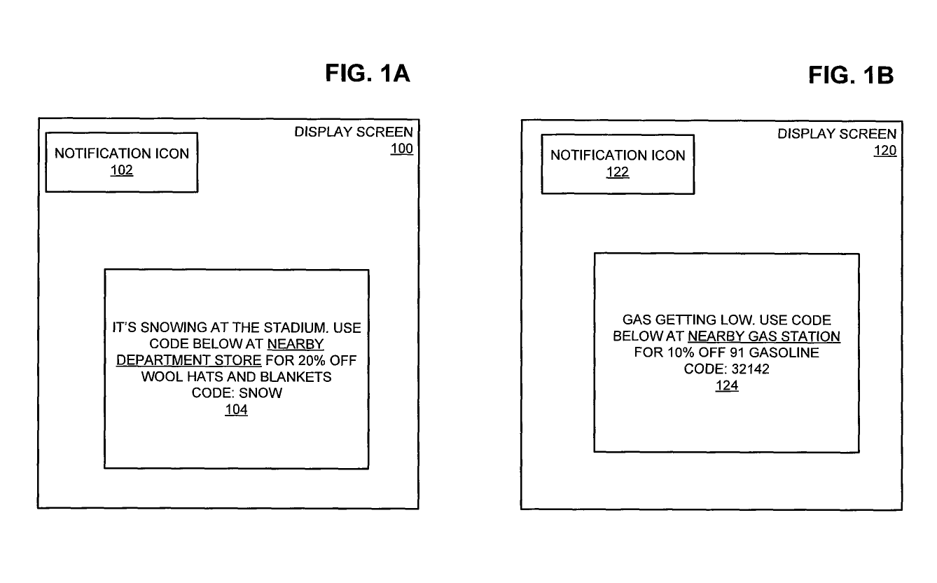

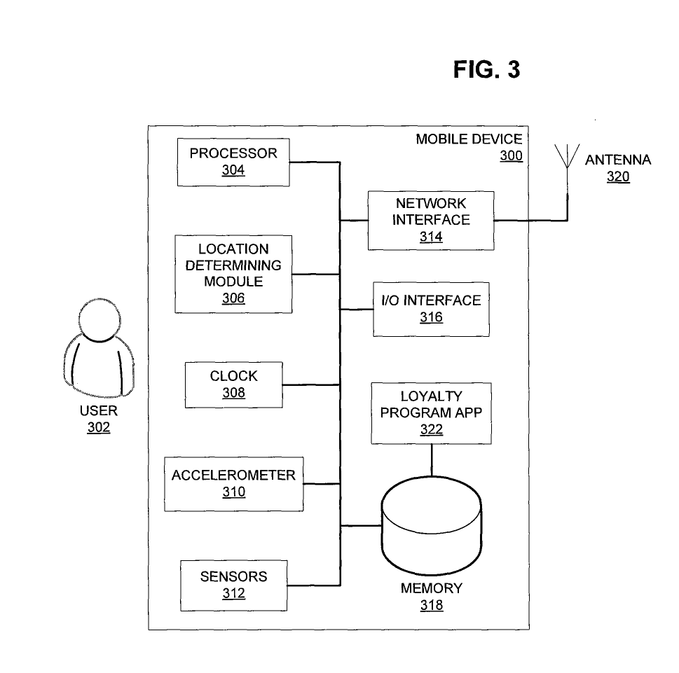

FIG. 1A illustrates a screen shot of a first discount code on a mobile device. The screen shot can be displayed on a mobile device display screen. The mobile device can be as illustrated in FIG. 3. For example, the mobile device can be accessible to a user while the user is walking along the street or driving in a car.

The mobile device can include a direction-generating module to compute a set of directions from a current location to a user-inputted destination. In this example, the mobile device is aware the user's destination is a football stadium.

The mobile device can determine a local weather at the football stadium over the wireless network, as discussed below. In this example, the mobile device determines the local weather conditions at the football stadium are cold and snowing.

The mobile device can determine a relevant discount code to display. For example, a department store along the way to the football stadium can be having a sale on wool hats and blankets. Alternatively, a special discount code valid for the customer can be received by the mobile device.

The display screen 100 can be any display area, such as a liquid crystal display (LCD), touch screen, or any other display area configured to display text or images to the user.

A notification icon 102 can be displayed to the user. The notification icon 102 can be combined with an audible or a tactile notification, such as an audible alert or a vibration of the mobile device. The notification icon 102 can notify the mobile device user that a discount code is available.

The discount code 104 can include a brief statement of the relevant facts (for example, the stadium is experiencing snow and cold weather) and an advertisement or a discount code. The advertisement or discount code can relate to the relevant facts displayed.

The “nearby department store” can be a link that will generate directions for a detour to the department store from a current user location. The discount code 104 can be provided to a cashier upon checkout. Once the user has completed his purchases, directions to the football stadium can resume.

The above screen shot improves relevancy of any displayed ad or discount code, thereby increasing marketing impact on the user.

FIG. 1B illustrates a screen shot of a second discount code on a mobile device. The mobile device can be as illustrated in FIG. 3. For example, the mobile device can be accessible to a user while the user is driving in a car.

In this example, the mobile device has determined the user's car is running low on gasoline. As discussed above, the fuel level can be determined by a mechanic during routine maintenance procedures. Alternatively, the mobile device can communicate with the user's automobile via short range wireless transmission.

The mobile device can query a server, as discussed below, for nearby gas stations with discounts. The server can also consider any gas station memberships or credit cards associated with the user to select a most relevant gas station. The server can also consider a current user location and a user destination to select a gas station that is on the way.

The display screen 120 can be any display area, such as a liquid crystal display (LCD), touch screen, or any other display area configured to display text or images to the user.

A notification icon 122 can be displayed to the user. The notification icon 122 can be combined with an audible or a tactile notification, such as an audible alert or a vibration of the mobile device. The notification icon 122 can notify the mobile device user that a discount code is available.

The discount code 124 can include a brief statement of the relevant facts (for example, automobile gasoline level is running low) and an advertisement or a discount code. The advertisement or discount code can relate to the relevant facts displayed.

The “nearby gas station” can be a link that will generate directions for a detour to the gas station from a current user location. The discount code 124 can be provided to a cashier upon checkout or inputted into an automated gasoline kiosk. Once the user has completed purchasing gasoline, directions to the user-inputted destination can resume.

The above screen shot improves relevancy of the ad for gasoline by only displaying the ad or discount code when the user actually needs gasoline.

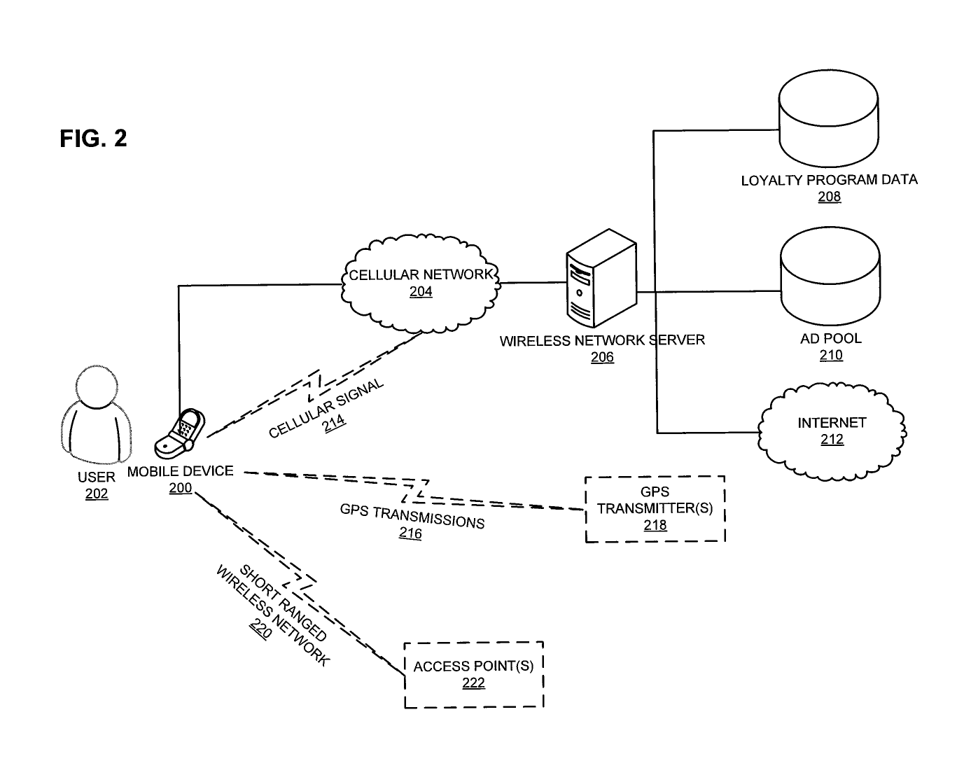

FIG. 2 illustrates an example system for delivering discount codes to a user. A mobile device 200 is used by a user 202. For example, the mobile device 200 can be a data-capable cellular phone, a wireless Personal Digital Assistant (PDA), a laptop computer, or any other mobile computing device.

The mobile device 200 is in communications with a cellular network 204. The cellular network includes a plurality of cellular towers, each tower providing wireless cellular signal coverage to a limited geographical area. The cellular network can be configured to carry both voice and data signals, and can be digital or analog. Each tower of the cellular network 204 can also transmit a local time for updating a clock on the mobile device 200. For example, the cellular network 204 can provide signal coverage to a defined geographical area.

The mobile device 200 communicates with a wireless network server 206 over the cellular network 204. The wireless network server 206 provides communication and data services to the mobile device 200, including forwarding voice and data connections/data.

The wireless network server 206 is in communications with a loyalty program data 208. The data 208 stores user demographics information and prior purchase histories. The data 208 can store any other information useful to a loyalty program.

The wireless network server 206 is in communications with an ad pool 210. The ad pool 210 stores advertisements and discount codes to be transmitted to the mobile device 200, as required. Ads and discount codes can be selected as discussed elsewhere. In addition, the ad pool 210 can store rules for generating discount codes, for example, when certain user behaviors are detected or certain merchant inputs are received. The generated discounted codes can be transmitted to the user 202.

The wireless network server 206 is in communication with the Internet 212. The server 206 can access information over the Internet 212 such as local weather information, geographic locations of merchants, or any other information required to provide time- and location-sensitive ads or discount codes.

The mobile device 200 can be configured to calculate a physical location. In an alternative embodiment, the wireless network server 206 can be configured to receive information from the mobile device 200 to calculate a physical location of the mobile device 200. This minimizes the required computing resources at the mobile device 200 by performing the computing at the wireless network server 206. This can be optimal if the wireless network 204 has unused bandwidth to transmit the information and results.

In one example, the mobile device 200 can receive cellular signals 214 from one or more cellular towers. A physical location can be approximated from known tower locations and signal strengths via various triangulation techniques. For example, the wireless network server 206 can maintain a list of cellular towers and associated locations. Each cellular signal is therefore associated with a tower whose location is known. By approximating a distance from the associated cellular tower based on the signal strength, a physical location of the mobile device 200 can be calculated.

In another example, the mobile device 200 can receive GPS transmissions 216 from GPS transmitters 218. A physical location can be approximated from the received GPS transmissions and an internal time. In this example, the mobile device 200 includes a GPS receiver.

In another example, the mobile device can receive short-range wireless network signals 220 from one or more access points 222. For example, short-range wireless networks can include Bluetooth, Wi-Fi, or other protocol networks. Because of such networks have a short range, the physical location of the mobile device 200 can be approximated as the location of the access points 222 detected by the mobile device 200. The wireless network server 206 can maintain a list of access points 222 and associated locations. In this example, the mobile device 200 includes a short-range wireless network transceiver to detect such networks.

It will be appreciated that the above approximations can be improved in accuracy by using various optimization and refinement strategies. It will also be appreciated that other methods of calculating a physical location of the mobile device 200 can be used.

The physical location of the mobile device 200 can be transmitted to the wireless network server 206, along with a local time. The local time can be retrieved from a clock included in the mobile device 200, updated with a network time transmitted by the cellular towers, as discussed above.

FIG. 3 illustrates an example mobile device for receiving and displaying discount codes to a user. The mobile device 300 can be a cellular phone, a PDA, or a similar portable device used by a user 302. The mobile device 300 can be configured to provide time and location information to a server, receive ads and discount codes from the server, and display the received ads and discount codes to a user 302.

The mobile device 300 can include a processor 304. The processor 304 can be a general purpose processor configured to execute computer-readable instructions operating the mobile device 300 and associated peripherals. It will be appreciated that any number of processors can be included in the mobile device 300, including specialized processors. The processor 304 can also be configured to execute the loyalty program application 322, as discussed below.

The mobile device 300 can include a location determining module 306. The module 306 can be a GPS receiver module configured to receive GPS signals and calculate a physical location of the mobile device 300 based on the received GPS signals and an internal clock time. The physical location calculation can be optimized by, for example, averaging the GPS signals over time or incorporating a signal from a known nearby location.

Alternatively, the module 306 can calculate a physical location by cellular signal triangulation, as discussed above. Similar strategies as discussed above regarding GPS reception can be applied to optimize cellular signal triangulation calculations.

Alternatively, the module 306 can calculate a physical location via short-range wireless network detection, as discussed above. This can provide an approximation of a physical location based on the range of the short-range wireless network.

Alternatively, the module 306 can be connected to a wired network, with an IP address from which a physical location can be calculated or approximated. For example, the mobile device 300 can plug into an Ethernet jack. The IP address can be associated with a physical location of the Ethernet jack, which approximates the physical location of the mobile device 300.

The mobile device 300 can include a clock 308. The clock 308 can provide a local time. The clock 308 can also provide an internal time for use with the GPS module. The clock 308 can be periodically updated from a server in communications with the mobile device 300.

The mobile device 300 includes an accelerometer 310. The accelerometer 310 can be configured to detect movement of the mobile device 300 and convert the movement into digital signals transmitted to the processor 304.

The mobile device 300 includes additional sensors 312. Additional sensors can include audio input devices or optical input devices. Audio input devices can include microphones. Optical input devices can include cameras or light sensors. The sensors 312 can be configured to detect appropriate input and convert the input into input signals transmitted to the processor 302.

The mobile device 300 can include a network interface 314. For example, the network interface 314 can communicate with a cellular wireless network, a wired network such as Ethernet, or a short range wireless network such as Bluetooth or Wi-Fi. The mobile device 300 can include multiple network interfaces or a network interface configured to interface with multiple networks. Wireless network interfaces can communicate via an antenna 320.

An Ethernet network allows the mobile device 300 to communicate when plugged in. The mobile device 300 can be assigned an IP address on the wired network. A short-range wireless network can be a Wi-Fi, Wi-Bree or Bluetooth network.

The mobile device 300 can include an input/output interface 316. The interface 316 can receive user inputs from an input device and convert the user inputs into user commands. For example, input devices can include a touch screen display, a keypad, a microphone, an optical device, a pointer device, a scroll wheel, or other input devices.

The interface 316 can also transmit output to an output device in a form accessible to the user 302. For example, output devices can include a touch screen, a display screen, a speaker, an audio-out jack, an electro-mechanical motor for providing tactile output, or other output devices.

The mobile device 300 can include a memory 318. The memory 318 can be read-only or read-write, persistent or volatile storage memory accessible to the processor 304. The memory 318 can store data required by the mobile device 300 for operation and applications for execution.

The mobile device 300 can include an antenna 320. The antenna 320 can be configured to transmit and receive wireless signals from a wireless network.

The mobile device 300 can store a loyalty program application 322 in the memory 318 for example. In one embodiment, the mobile device 300 executes an installed application 322 which tracks user demographic information and purchase history. The application 322 can combine this information with a current time and location and select ads or discount codes (stored locally or on a server) for display to the user, as discussed above. Alternatively, this functionality can be provided by a server, as discussed above.

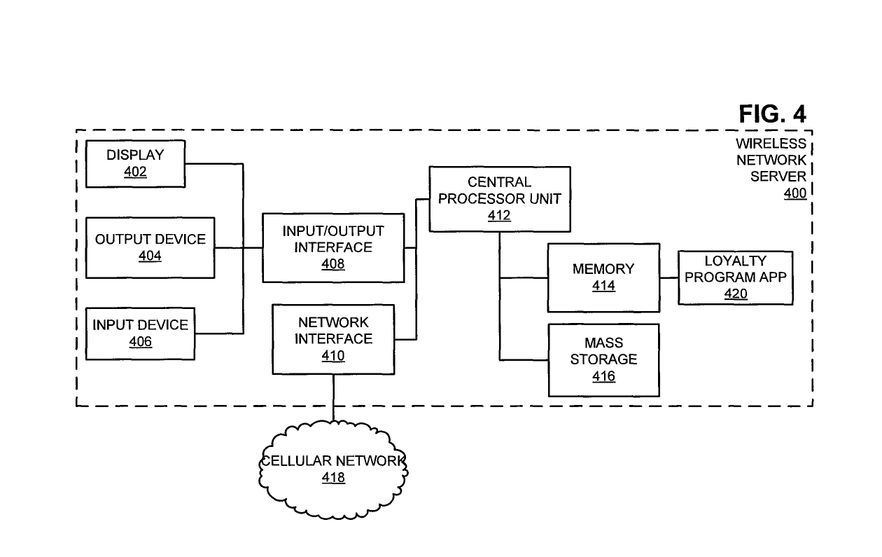

FIG. 4 illustrates an example server for selecting and transmitting discount codes to a user. The server 400 can interact with a user via a workstation over a network or a mobile device (illustrated above) over a wireless network to provide ads to users. For example, the server 400 can be a standard computing server configured to communicate with workstations and mobile devices over a plurality of networks. Alternatively, the server 400 can be any computing device.

The server 400 includes a display 402. The display 402 can be equipment that displays viewable images, graphics, and text generated by the server 400 to a user. For example, the display 402 can be a cathode ray tube or a flat panel display such as a TFT LCD. The display 402 includes a display surface, circuitry to generate a viewable picture from electronic signals sent by the server 400, and an enclosure or case. The display 402 can interface with an input/output interface 408, which converts data from a central processor unit 412 to a format compatible with the display 402.

The server 400 includes one or more output devices 404. The output device 404 can be any hardware used to communicate outputs to the user. For example, the output device 404 can be audio speakers and printers or other devices for providing output.

The server 400 includes one or more input devices 406. The input device 406 can be any computer hardware used to receive inputs from the user. The input device 406 can include keyboards, mouse pointer devices, microphones, scanners, video and digital cameras, etc.

The server 400 includes an input/output interface 408. The input/output interface 408 can include logic and physical ports used to connect and control peripheral devices, such as output devices 404 and input devices 406. For example, the input/output interface 408 can allow input and output devices 404 and 406 to communicate with the server 400.

The server 400 includes a network interface 410. The network interface 410 includes logic and physical ports used to connect to one or more networks. For example, the network interface 410 can accept a physical network connection and interface between the network and the workstation by translating communications between the two. Example networks can include Ethernet, or other physical network infrastructure. Alternatively, the network interface 410 can be configured to interface with wireless network. Alternatively, the server 400 can include multiple network interfaces for interfacing with multiple networks.

As illustrated, the network interface 410 communicates over a wired network and a cellular network. It will be appreciated that the server 400 can communicate over any combination of wired, wireless, or other networks.

The server 400 includes a central processing unit (CPU) 412. The CPU 412 can be an integrated circuit configured for mass-production and suited for a variety of computing applications. The CPU 412 can sit on a motherboard within the server 400 and control other workstation components. The CPU 412 can communicate with the other workstation components via a bus, a physical interchange, or other communication channel.

The server 400 includes memory 414. The memory 414 can include volatile and non-volatile memory accessible to the CPU 412. The memory can be random access and provide fast access for graphics-related or other calculations. In an alternative, the CPU 412 can include on-board cache memory for faster performance.

The server 400 includes mass storage 416. The mass storage 416 can be volatile or non-volatile storage configured to store large amounts of data. The mass storage 416 can be accessible to the CPU 412 via a bus, a physical interchange, or other communication channel. For example, the mass storage 416 can be a hard drive, a RAID array, flash memory, CD-ROMs, DVDs, HD-DVD or Blu-Ray mediums.

The server 400 communicates with a cellular network 4180 via the network interface 410. The network 418 can be as discussed above. The server 400 can communicate with a mobile device over the network 418.

Alternatively, the network interface 410 can communicate over any network configured to carry digital information. For example, the network interface 410 can communicate over an Ethernet network, the Internet, a wireless network, a cellular data network, or any Local Area Network or Wide Area Network.

The server 400 can execute a loyalty program application 420 stored in the memory 414. The application 420 can track user demographic information, purchase history, current location, and time as discussed above. The information can be used to select relevant ads and discount codes for transmission to a user mobile device for display. In addition, the application 420 can interface with a loyalty program data store and an ad pool as illustrated above.

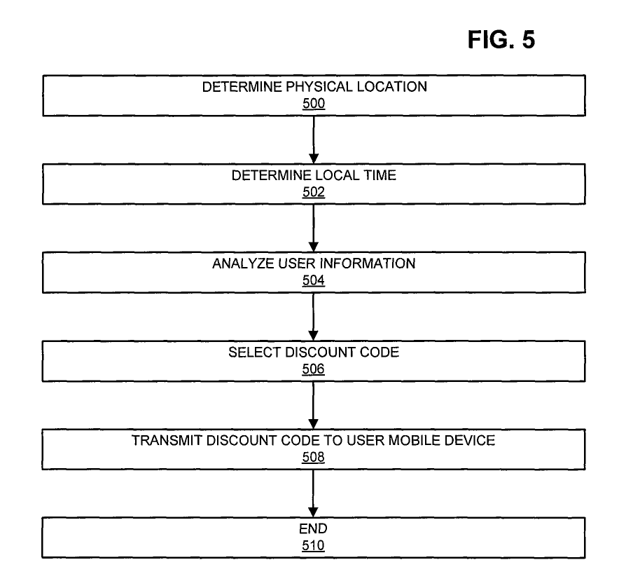

FIG. 5 illustrates a procedure for selecting and transmitting discount codes to a user. The procedure can execute on a loyalty program application as illustrated above. The application can interface with a loyalty program data store and an ad pool as illustrated above.

In one embodiment, the application can execute on a user mobile device. In another embodiment, the application can execute on a server in communication with a user mobile device.

In 500, the application determines a physical location of the mobile device. As discussed above, various systems and modules can be available to the mobile device or server to determine a geographical location. The location can be available in a variety of formats, such as a longitude and latitude, a street address, or any other conventional format.

In 502, the application determines a local time. As discussed above, various systems and modules can be available to the mobile device or server to determine a local time. For example, the mobile device can include an on-board clock tracking a local time. The clock can be periodically updated via wireless signals from a wireless network. In another example, the server can maintain a clock and compute a local time of the mobile device based on its location, determined above.

In 504, the application analyzes user information, including a purchase history and user demographic information. User information, as discussed above, can include loyalty program information such as user purchase history, prior user behavior, and user demographic information. The user information can be stored in a loyalty program data store.

Additional information can be retrieved and analyzed such as local weather, a user destination, and any other information useful to select relevant ads or discount codes.

In 506, the application selects or generates a discount code. The discount code can be stored in a discount code data store or dynamically selected based on predetermined rules set by an administrator or merchant. For example, a gas station can set up a discount code rule to generate a 10% off discount code for each customer participating in its loyalty program whenever the customer's location is within two miles of the gas station.

Alternatively, the application can select or generate an ad. The ads can be stored in an ad pool and selected based on the above information and predetermined rules.

In 508, the application transmits the discount code to the user mobile device. The discount code or ad can be transmitted to the mobile device wirelessly. The discount code or ad can include both text and multimedia content. The mobile device can notify the user of the discount code or ad via a notification icon and alert, as discussed above.

In 510, the application can exit the procedure.

As discussed above, one example embodiment of the present invention can be a method for transmitting a discount code. The method includes determining a physical location of a user mobile device. The method includes determining a user local time. The method includes analyzing a user purchase history stored within a loyalty program data store. The method includes selecting a discount code based, in part, on the location, the local time, and the user purchase history. The method includes transmitting the discount code to the user mobile device. The discount code can be selected from a data store of available discount codes. The physical location can be determined by at least one of: a Global Positioning Satellite (GPS) system, short range network detection, and cellular tower triangulation. The discount code can be further selected, in part, based on a retailer inventory of products to be sold before expiration. The loyalty program data store can associate the user purchase history with user demographic information and a user identifier. The discount code can be transmitted as a SMS message. The discount code can be valid for a specified time period at a specified merchant location.

Another example embodiment of the present invention can be a system for transmitting a discount code. The system includes a server. The server can be configured to determine a physical location of a user mobile device. The server can be configured to determine a user local time. The server can be configured to analyze a user purchase history stored within a loyalty program data store. The server can be configured to select a discount code based, in part, on the location, the local time, and the user purchase history. The server can be configured to transmit the discount code to the user mobile device.

The discount code can be selected from a data store of available discount codes. The physical location can be determined by at least one of: a Global Positioning Satellite (GPS) system, short range network detection, and cellular tower triangulation. The discount code can be further selected, in part, based on a retailer inventory of products to be sold before expiration. The loyalty program data store can associate the user purchase history with user demographic information and a user identifier. The discount code can be transmitted as a SMS message. The discount code can be valid for a specified time period at a specified merchant location.

Another example embodiment of the present invention can be a computer-readable storage medium including instructions adapted to execute a method for transmitting a discount code. The method includes determining a physical location of a user mobile device. The method includes determining a user local time. The method includes analyzing a user purchase history stored within a loyalty program data store. The method includes selecting a discount code based, in part, on the location, the local time, and the user purchase history. The method includes transmitting the discount code to the user mobile device. The discount code can be selected from a data store of available discount codes. The physical location can be determined by at least one of: a Global Positioning Satellite (GPS) system, short range network detection, and cellular tower triangulation. The discount code can be further selected, in part, based on a retailer inventory of products to be sold before expiration. The loyalty program data store can associate the user purchase history with user demographic information and a user identifier. The discount code can be transmitted as a SMS message. The discount code can be valid for a specified time period at a specified merchant location.

It can be appreciated that an embodiment of the present invention can be a method for displaying targeted advertisements. The method includes executing a monitoring application on a mobile device, the mobile device configured with a sensor. The method includes detecting a start of a user purchase decision making process via a sensor reading, wherein the sensor reading includes at least one of: a search query, a user command for the mobile device, a user geographical location, a local time, a user phone call, a user local environment, and a user behaviour history. The method includes selecting a relevant ad based on the start of the user purchase decision making process and the sensor reading. The method includes displaying the selected ad to the user during the user purchase decision making process. The ad can be an inducement for a similar product when the user is deciding to purchase a competing product. The ad can be for a recommended product related to the user purchase decision making process. An indication of the start of the user purchase decision making process and the sensor reading can be transmitted to a server. The sensor reading can be transmitted to a server, and the relevant ad can be selected by the server and transmitted to the mobile device for display. User identifiable information can be secured via encryption. The ad can be selected from a data store of pre-approved ads.

The specific embodiments described in this document represent examples or embodiments of the present invention, and are illustrative in nature rather than restrictive. In the above description, for purposes of explanation, numerous specific details are set forth in order to provide a thorough understanding of the invention. It will be apparent, however, to one skilled in the art that the invention can be practiced without these specific details.

Reference in the specification to “one embodiment” or “an embodiment” or “some embodiments” means that a particular feature, structure, or characteristic described in connection with the embodiment is included in at least one embodiment of the present invention. Features and aspects of various embodiments may be integrated into other embodiments, and embodiments illustrated in this document may be implemented without all of the features or aspects illustrated or described. It will be appreciated to those skilled in the art that the preceding examples and embodiments are exemplary and not limiting.

While the system, apparatus and method have been described in terms of what are presently considered to be the most practical and effective embodiments, it is to be understood that the disclosure need not be limited to the disclosed embodiments. It is intended that all permutations, enhancements, equivalents, combinations, and improvements thereto that are apparent to those skilled in the art upon a reading of the specification and a study of the drawings are included within the true spirit and scope of the present invention. The scope of the disclosure should thus be accorded the broadest interpretation so as to encompass all such modifications and similar structures. It is therefore intended that the application includes all such modifications, permutations and equivalents that fall within the true spirit and scope of the present invention.

What is claimed is:

1. A method for transmitting a discount code, comprising:
determining a physical location of a user mobile device;
determining a user local time;
analyzing a user purchase history stored within a loyalty program data store;
selecting a discount code based, in part, on the location, the local time, and the user purchase history;
transmitting the discount code to the user mobile device.

2. The method of claim 1, wherein the discount code is selected from a data store of available discount codes.

3. The method of claim 1, wherein the physical location is determined by at least one of: a Global Positioning Satellite (GPS) system, short range network detection, and cellular tower triangulation.

4. The method of claim 1, wherein the discount code is further selected, in part, based on a retailer inventory of products to be sold before expiration.

5. The method of claim 1, wherein the loyalty program data store associates the user purchase history with a user demographic information and a user identifier.

6. The method of claim 1, wherein the discount code is transmitted as a SMS message.

7. The method of claim 1, wherein the discount code is valid for a specified time period at a specified merchant location.

8. A system for transmitting a discount code, comprising:
a server, the server configured to,
determine a physical location of a user mobile device,
determine a user local time,
analyze a user purchase history stored within a loyalty program data store,
select a discount code based, in part, on the location, the local time, and the user purchase history, and
transmit the discount code to the user mobile device.

9. The system of claim 7, wherein the discount code is selected from a data store of available discount codes.

10. The system of claim 7, wherein the physical location is determined by at least one of: a Global Positioning Satellite (GPS) system, short range network detection, and cellular tower triangulation.

11. The system of claim 7, wherein the discount code is further selected, in part, based on a retailer inventory of products to be sold before expiration.

12. The system of claim 7, wherein the loyalty program data store associates the user purchase history with a user demographic information and a user identifier.

13. The system of claim 7, wherein the discount code is transmitted as a SMS message.

14. The system of claim 7, wherein the discount code is valid for a specified time period at a specified merchant location.

15. A computer-readable storage medium including instructions adapted to execute a method for transmitting a discount code, the method comprising:
determining a physical location of a user mobile device;
determining a user local time;
analyzing a user purchase history stored within a loyalty program data store;
selecting a discount code based, in part, on the location, the local time, and the user purchase history;
transmitting the discount code to the user mobile device.

16. The medium of claim 15, wherein the discount code is selected from a data store of available discount codes.

17. The medium of claim 15, wherein the physical location is determined by at least one of: a Global Positioning Satellite (GPS) system, short range network detection, and cellular tower triangulation.

18. The medium of claim 15, wherein the discount code is further selected, in part, based on a retailer inventory of products to be sold before expiration.

19. The medium of claim 15, wherein the loyalty program data store associates the user purchase history with a user demographic information and a user identifier.

20. The medium of claim 15, wherein the discount code is transmitted as a SMS message and the discount code is valid for a specified time period at a specified merchant location.
